(19) United States
(12) Patent Application Publication
(10) Pub. No.: US 2013/0125561 A1
(43) Pub. Date: May 23, 2013

(54) GEARED TURBOFAN WITH DISTRIBUTED ACCESSORY GEARBOXES

(71) Applicants: Frederick M. Schwarz, Giastonbury, CT (US); Michael Winter, New Haven, CT (US)

(72) Inventors: Frederick M. Schwarz, Giastonbury, CT (US); Michael Winter, New Haven, CT (US)

(21) Appl. No.: 13/459,783

(22) Filed: Apr. 30, 2012

Related U.S. Application Data
(63) Continuation-in-part of application No. 11/947,842, filed on Nov. 30, 2007.

(51) Int. Cl. F02C 6/00

(52) U.S. Cl. CPC F02C 6/00
USPC 60/802

(57) ABSTRACT

A disclosed gas turbine engine includes a core engine defined about an engine centerline axis, the core engine including a compressor section driven through a shaft by a turbine section. A core nacelle surrounds the core engine and a fan nacelle is mounted at least partially around the core nacelle to define a fan bypass flow path for a bypass airflow. A fan section disposed within the fan nacelle is driven by the turbine section of the core engine through a geared architecture. An engine pylon supports the core nacelle and the fan nacelle. A towershaft is driven by the shaft of the core engine and drives a generator mounted within the core nacelle. The generator powers an electric motor mounted within the engine pylon. The electric motor drives a plurality of accessory components that are also mounted within the engine pylon.

### CROSS REFERENCE TO RELATED APPLICATION

This application is a continuation in part of U.S. application Ser. No. 11/947,842 filed on Nov. 30, 2007.

### BACKGROUND

A gas turbine engine typically includes a fan section, and a core engine including a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

A speed reduction device such as an epicyclical gear assembly may be utilized to drive the fan section such that the fan section may rotate at a speed different than the turbine section so as to increase the overall propulsive efficiency of the engine.

Gear drive fans provide for increased bypass ratios that in turn improve propulsive efficiency. Increased bypass not only results from increases in fan section diameter, but also reduction in core engine size. In conventional gas turbine engines, accessory items are mounted within a core nacelle surrounding the core engine. However, a smaller core engine size, as is facilitated by the more efficient fan sections, decreases the space available for mounting of required accessory components.

Accordingly, it is desirable to provide alternate mounting arrangements for accessories utilized for a gas turbine engine.

### SUMMARY

An engine pylon assembly according to an exemplary embodiment of this disclosure, among other possible things includes, a core nacelle defined about an engine centerline axis, a fan nacelle mounted at least partially around the core nacelle to define a fan bypass flow path for a fan bypass airflow, an engine pylon to support the core nacelle and the fan nacelle, a generator mounted within the core nacelle for producing electric energy, an electric motor mounted within the engine pylon, and at least one accessory component mounted within the engine pylon and drivable by the electric motor.

A further embodiment of the foregoing engine pylon assembly, including a gearbox mounted within the core nacelle for driving the generator.

A further embodiment of any of the foregoing engine pylon assemblies, including at least one towershaft which extends from a core engine within the core nacelle for driving the generator.

A further embodiment of any of the foregoing engine pylon assemblies, including a second gearbox drivable by the electric motor and a plurality of accessory components drivable by the second gearbox.

A further embodiment of any of the foregoing engine pylon assemblies, the electric motor and second gearbox are mounted within the engine pylon aft of the fan nacelle.

A further embodiment of any of the foregoing engine pylon assemblies, further comprising a variable area fan nozzle movable to vary a fan nozzle exit area during engine operation to adjust a pressure ratio of the fan bypass airflow during engine operation.

A further embodiment of any of the foregoing engine pylon assemblies, further comprising a core engine within the core nacelle to drive a fan within the fan nacelle through a geared architecture including a gear reduction ratio of greater than or equal to about 2.3.

A further embodiment of any of the foregoing engine pylon assemblies, wherein the core engine includes a low pressure turbine which defines a pressure ratio that is greater than about five (5).

A further embodiment of any of the foregoing engine pylon assemblies, wherein the bypass flow defines a bypass ratio greater than about six (6).

A further embodiment of any of the foregoing engine pylon assemblies, wherein the bypass flow defines a bypass ratio greater than about ten (10).

An gas turbine engine assembly according to an exemplary embodiment of this disclosure, among other possible things includes, a core engine defined about an engine centerline axis, the core engine including a compressor section driven through a shaft by a turbine section, a core nacelle defined about the core engine, a fan nacelle mounted at least partially around the core nacelle to define a fan bypass flow path for a fan bypass airflow, a fan section disposed within the fan nacelle, wherein the fan section is driven by the turbine section of the core engine through a geared architecture, an engine pylon to support the core nacelle and the fan nacelle, a towershaft driven by the shaft of the core engine, a generator mounted within the core nacelle and driven by the tower shaft and an electric motor driven by electric power generated by the generator, wherein the electric motor is mounted within the engine pylon axially aft of the fan nacelle.

A further embodiment of the foregoing gas turbine engine assembly, wherein the electric motor drives a plurality of accessory components mounted within the engine pylon.

A further embodiment of the foregoing gas turbine engine assembly including a gearbox driven by the electric motor and mounted in the engine pylon for driving the plurality of accessory components.

A further embodiment of the foregoing gas turbine engine assembly wherein the electric motor is mounted below a wing.

A further embodiment of the foregoing gas turbine engine assembly including a variable area fan nozzle movable to vary a fan nozzle exit area during engine operation to adjust a pressure ratio of the fan bypass airflow during engine operation.

A further embodiment of the foregoing gas turbine engine assembly wherein the compressor section comprises a high pressure compressor and the turbine section comprises a high pressure turbine that drives the high pressure compressor through the shaft.

A further embodiment of the foregoing gas turbine engine assembly wherein a ratio of a diameter of the fan nacelle to a diameter of the core engine nacelle is greater than about 6.

Although the different examples have the specific components shown in the illustrations, embodiments of this invention are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

### DETAILED DESCRIPTION

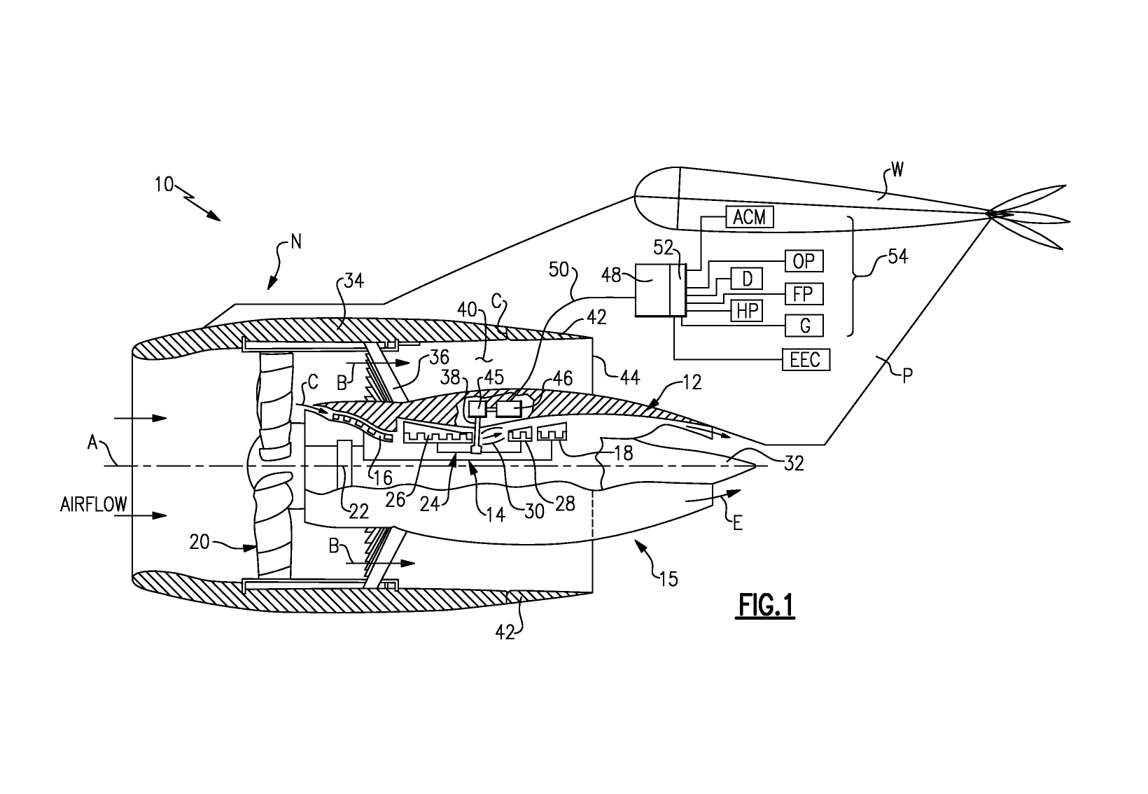

FIG. 1 illustrates a general partial fragmentary schematic view of a gas turbine engine 10 suspended from an engine pylon P within an engine nacelle assembly N as is typical of an aircraft designed for subsonic operation. The engine pylon P or other support structure is typically mounted to an aircraft wing W; however, the engine pylon P may alternatively extend from other aircraft structure such as an aircraft empennage.

The turbofan engine 10 includes a core engine 15 within a core nacelle 12 that houses a low spool 14 and high spool 24. The low spool 14 includes a low pressure compressor 16 and low pressure turbine 18. The low spool 14 may drive a fan section 20 through a gear train 22. The high spool 24 includes a high pressure compressor 26 and high pressure turbine 28. A combustor 30 is arranged between the high pressure compressor 26 and high pressure turbine 28. The low and high spools 14, 24 rotate about an engine axis of rotation A.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

In one example, the high pressure turbine 28 includes at least two stages to provide a double stage high pressure turbine 28. In another example, the high pressure turbine 28 includes only a single stage. In one example the low pressure turbine 18 includes between about 3 and 6 stages. As used herein, a “high pressure” compressor or turbine experiences a higher pressure than a corresponding “low pressure” compressor or turbine.

The example gas turbine engine includes the fan section 20 that comprises in one non-limiting embodiment less than about 26 fan blades. In another non-limiting embodiment, the fan section 20 includes less than about 20 fan blades. Moreover, in one disclosed embodiment the low pressure turbine 18 includes no more than about 6 turbine rotors.

In another non-limiting example embodiment the low pressure turbine 18 includes about 3 turbine rotors. A ratio between the number of fan blades and the number of low pressure turbine rotors is between about 3.3 and about 8.6. The example low pressure turbine 18 provides the driving power to rotate the fan section 20 and therefore the relationship between the number of turbine rotors in the low pressure turbine 18 and the number of blades in the fan section 20 disclose an example gas turbine engine 10 with increased power transfer efficiency.

The engine 10 in the disclosed embodiment is a high-bypass geared architecture aircraft engine. In one disclosed, non-limiting embodiment, the engine 10 bypass ratio is greater than about six (6) to ten (10), the gear train 22 is an epicyclical gear train such as a planetary gear system or other gear system with a gear reduction ratio of greater than about 2.3 and the low pressure turbine 18 has a pressure ratio that is greater than about 5. In one disclosed embodiment, the engine 10 bypass ratio is greater than six (6:1), with one example embodiment being about ten (10:1). The turbofan diameter is significantly larger than that of the low pressure compressor 16 and the low pressure turbine 18.

The geared architecture 22 may be an epicycle gear train, such as a planetary gear system, star gear system or other known gear system, with a gear reduction ratio of greater than about 2.3. It should be understood, however, that the above parameters are only exemplary of one embodiment of a geared architecture engine and that the present invention is applicable to other gas turbine engines including direct drive turbofans.

Airflow enters a fan nacelle 34, which at least partially surrounds the core nacelle 12. The fan section 20 communicates airflow into the core nacelle 12 to the low pressure compressor 16 and the high pressure compressor 26. Core airflow C compressed by the low pressure compressor 16 and the high pressure compressor 26 is mixed with fuel in the combustor 30, ignited and expanded over the high pressure turbine 28 and low pressure turbine 18. The turbines 28, 18 are coupled for rotation with, respective spools 24, 14 to rotationally drive the compressors 26, 16 and, through the optional gear train 22, the fan section 20 in response to the expansion. A core engine exhaust E exits the core nacelle 12 through a core nozzle defined between the core nacelle 12 and a tail cone 32.

The core nacelle 12 is at least partially supported within the fan nacelle 34 by structure 36 often generically referred to as Fan Exit Guide Vanes (FEGVs), upper bifurcations, and lower bifurcations. A bypass flow path 40 is defined between the core nacelle 12 and the fan nacelle 34. The engine 10 generates a high bypass flow arrangement with a bypass ratio in which approximately 80 percent of the airflow entering the fan nacelle 34 becomes bypass flow B. The bypass flow B communicates through the generally annular fan bypass flow path 40 and is discharged from the engine 10 through a variable area fan nozzle (VAFN) 42 which defines a fan nozzle exit area 44 between the fan nacelle 34 and the core nacelle 12 at a fan nacelle end segment downstream of the fan section 20.

Thrust is a function of density, velocity, and area. One or more of these parameters can be manipulated to vary the amount and direction of thrust provided by the bypass flow B. The VAFN 42 operates to effectively vary the area of the fan nozzle exit area 44 to selectively adjust the pressure ratio of the bypass flow B in response to a controller.

Low pressure ratio turbofans are desirable for their high propulsive efficiency. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment the low fan pressure ratio is less than about 1.45.

“Low corrected fan tip speed” is the actual fan tip speed in ft/sec divided by an industry standard temperature correction of [(Tram °R)/518.7)^{0.5}]. The “Low corrected fan tip speed”, as disclosed herein according to one non-limiting embodiment, is less than about 1150 ft/second.

A significant amount of thrust is provided by the bypass flow B due to the high bypass ratio. The fan section 20 of the engine 10 is preferably designed for a particular flight condition—typically cruise at about 0.8M and about 35,000 feet. The flight condition of 0.8 Mach and 35,000 ft., with the engine at its best fuel consumption—also known as “bucket cruise Thrust Specific Fuel Consumption (‘TSFC’)”—is the industry standard parameter of pound-mass (lbm) of fuel per hour being burned divided by pound-force (lbf) of thrust the engine produces at that minimum point.

As the fan blades within the fan section 20 are efficiently designed at a particular fixed stagger angle for an efficient cruise condition, the VAFN 42 is operated to effectively vary the fan nozzle exit area 44 to adjust fan bypass air flow such that the angle of attack or incidence on the fan blades is maintained close to the design incidence for efficient engine operation at other flight conditions, such as landing and takeoff to thus provide optimized engine operation over a range of flight conditions with respect to performance and other operational parameters such as noise levels.

The example geared turbofan engine 10 includes a large bypass ratio that results not only from increases in fan section diameter, but also a reduction in core engine size relative to other core engines within a similar thrust class. Moreover, because the example geared turbofan engine 10 includes a low pressure turbine with fewer stages and of smaller diameter, space within the core engine 15 that could be utilized for mounting of accessory items is reduced.

Accessories components generally indicated at 54 located within the pylon P and utilized for operation of the example gas turbine engine 10 can include fuel pumps (FP), oil pumps (OP), deoilers (D), generators (G), and hydraulic pumps (HP). In this disclosed example, these accessory items are mounted within the engine pylon P and are powered by an electric motor 48. The electric motor 48 is powered by electric energy produced by a starter/generator 46 mounted within the core engine 15; the power produced by the starter/generator 46 is delivered to the motor 48 via cable 50. The starter/generator 46 is in turn driven by a tower shaft 38 through a gearbox 45.

The example tower shaft 38 takes power off of the core engine 15. The towershaft arrangement 38 extends from the core engine 15 and drives the gearbox 45. The gearbox 45 is mounted to the core engine 15 within the core nacelle 12. The example towershaft 38 may include a single towershaft which is in meshed engagement with the high spool 24.

The gearbox 45 is one of a limited number of accessory components mounted within the core engine 15. The gearbox 45 drives the starter/generator 46 to produce electric power that can drive the remaining accessory components 54 mounted within the pylon P and driven by the electric motor 48. The gearbox 45 provides a desired gear ratio for driving the starter/generator 46 at correct speed. Moreover, the starter/generator 46 drives the tower shaft 38 to turn the high spool 24 for starting of the gas turbine engine 10 as is known.

Accordingly, only a limited number of accessory components are mounted to the core engine 15 to provide a distributed accessory arrangement. The distributed accessory arrangement provides for some components to be located in the core nacelle 12 and to be driven directly by the gearbox 45 such as the starter/generator 46. Still other components are located remote from the core nacelle 12 within the pylon P.

The electric motor 48 may drive a second gearbox 52 such that several different components and accessories can be driven at different and proper speeds. As is shown in FIG. 1, the electric motor 48 mounted within the engine pylon P can drive the accessories 54 including the deoiler D, the hydraulic pump HP, the oil pump OP, the fuel pump FP, the generator G and other devices and components powered by the gas turbine engine which saves space within the core nacelle 12. Location of the accessory components 54 within the pylon P also provides a relatively lower temperature environment that thereby increases component life. Moreover, commonly inspected and maintained accessories such as the hydraulic pumps HP can be located within the pylon P to simplify and ease access. Other components such as for example the engine fuel pump (FP) and the starter/generator 46 could be located within the engine core nacelle 12.

In this disclosed example, the accessory components 54 and the electric motor 48 are located within the pylon (P) at a position aft of the fan nacelle 44. Moreover, the electric motor 48 is mounted radially outward from an external surface of the fan nacelle 34. Further, in this disclosed example, the electric motor 48 and the accessory components 54 are mounted within the pylon (P) below the wing (W).

It should be understood that any number and type of accessory components 54 are usable with the present invention. Furthermore, accessory components may alternatively, or in addition, be located in other areas such as in the wing W, core nacelle, fuselage, etc. Optimization of the core nacelle 12 increases the overall propulsion system efficiency to thereby, for example, compensate for the additional weight of the extended length towershaft. This arrangement also frees up additional space within the core nacelle below the engine case structure for other externals and accessory components.

It should be understood that relative positional terms such as “forward,” “aft,” “upper,” “lower,” “above,” “below,” and the like are with reference to the normal operational attitude of the vehicle and should not be considered otherwise limiting.

Although an example embodiment has been disclosed, a worker of ordinary skill in this art would recognize that certain modifications would come within the scope of this disclosure. For that reason, the following claims should be studied to determine the scope and content of this disclosure.

1. An engine pylon assembly for a gas turbine engine comprising:
a core nacelle defined about an engine centerline axis;
a fan nacelle mounted at least partially around the core nacelle to define a fan bypass flow path for a fan bypass airflow;
an engine pylon to support the core nacelle and the fan nacelle;
a generator mounted within the core nacelle for producing electric energy;
an electric motor mounted within the engine pylon; and
at least one accessory component mounted within the engine pylon and drivable by the electric motor.

2. The assembly as recited in claim 1, including a gearbox mounted within the core nacelle for driving the generator.

3. The assembly as recited in claim 1, including at least one towershaft which extends from a core engine within the core nacelle for driving the generator.

4. The assembly as recited in claim 2, including a second gearbox drivable by the electric motor and a plurality of accessory components drivable by the second gearbox.

5. The assembly as recited in claim 4, wherein the electric motor and second gearbox are mounted within the engine pylon aft of the fan nacelle.

6. The assembly as recited in claim 1, further comprising a variable area fan nozzle movable to vary a fan nozzle exit area during engine operation to adjust a pressure ratio of the fan bypass airflow during engine operation.

7. The assembly as recited in claim 1, further comprising a core engine within the core nacelle to drive a fan within the fan nacelle through a geared architecture including a gear reduction ratio of greater than or equal to about 2.3.

8. The assembly as recited in claim 1, wherein the core engine includes a low pressure turbine which defines a pressure ratio that is greater than about five (5).

9. The assembly as recited in claim 1, wherein the bypass flow defines a bypass ratio greater than about six (6).

10. The assembly as recited in claim 1, wherein the bypass flow defines a bypass ratio greater than about ten (10).

11. A gas turbine engine system comprising:
a core engine defined about an engine centerline axis, the core engine including a compressor section driven through a shaft by a turbine section;
a core nacelle defined about the core engine;
a fan nacelle mounted at least partially around the core nacelle to define a fan bypass flow path for a fan bypass airflow;
a fan section disposed within the fan nacelle, wherein the fan section is driven by the turbine section of the core engine through a geared architecture;
an engine pylon to support the core nacelle and the fan nacelle; and
a towershaft driven by the shaft of the core engine;
a generator mounted within the core nacelle and driven by the tower shaft;
an electric motor driven by electric power generated by the generator, wherein the electric motor is mounted within the engine pylon axially aft of the fan nacelle.

12. The gas turbine engine as recited in claim 11, wherein the electric motor drives a plurality of accessory components mounted within the engine pylon.

13. The gas turbine engine as recited in claim 12, including a gearbox driven by the electric motor and mounted in the engine pylon for driving the plurality of accessory components.

14. The gas turbine engine as recited in claim 11, wherein the electric motor is mounted below a wing.

15. The gas turbine engine as recited in claim 11, including a variable area fan nozzle movable to vary a fan nozzle exit area during engine operation to adjust a pressure ratio of the fan bypass airflow during engine operation.

16. The gas turbine engine as recited in claim 11, wherein the compressor section comprises a high pressure compressor and the turbine section comprises a high pressure turbine that drives the high pressure compressor through the shaft.

17. The gas turbine engine as recited in claim 11, wherein a ratio of a diameter of the fan nacelle to a diameter of the core engine nacelle is greater than about 6.
